(19) United States
(12) Patent Application Publication
(10) Pub. No.: US 2010/0228398 A1
(43) Pub. Date: Sep. 9, 2010

(54) System and method for remotely monitoring and controlling pump jacks

(75) Inventors: James Powers, Eckville (CA); Cal Riemer, Sylvan Lake (CA)

Correspondence Address: GOWLING LAFLEUR HENDERSON LLP, SUITE 1400, 700 2ND ST. SW, CALGARY, AB, T2P 4V5, CA

(73) Assignee: Riemer Powers Corp., Eckville (CA)

(21) Appl. No.: 12/379,919

(22) Filed: Mar. 4, 2009

(51) Int. Cl. G05D 7/00; G06F 15/00

(52) U.S. Cl. 700/282; 702/188; 726/5; 715/771; 709/217

(57) ABSTRACT

A simplified system and method for remotely monitoring and optionally further controlling pumpjack operating parameters of a pumpjack located at a distant site but within wireless cell phone station reception. Sensors situated on a pumpjack monitor and create analog output of operational conditions of the pumpjack. Digitizing means digitize the analog output of the sensors to digital data, and modem means transmit the digital data via a wireless cellular network to a network server. A user's computer communicates with the network server via the internet, and accesses the digital data to obtain information regarding the operational conditions of the pumpjack.

### FIELD OF THE INVENTION

This invention relates to a system and method for remotely monitoring, and further optionally controlling, pumpjacks.

### BACKGROUND OF THE INVENTION AND DESCRIPTION OF THE PRIOR ART

Systems and methods for remotely controlling equipment over the internet are known.

For example, FIG. 1 hereto shows a known method/system of the prior art for remotely controlling an electric motor 2. A web relay device 3 possesses at least one relay switch (not shown) which when actuated is used to turn “on” and “off” electrical power supply 4 to various operating systems on a device such as the large electrical motor 2 shown. Of course, while only electrical power supply 4 to a large electrical motor 2 is shown as being controlled, existing web relays 3 typically have a plurality of “on”/“off” relays which may be used to control other electrically actuated devices and subsystems, such as other larger solenoids or electrically operated valves which control the flow of fluids as is common in the oil processing, transporting and refining industries.

Such prior art web relays 3 typically have a dynamic IP address, and may be connected directly to the world wide web (internet) 7 using a RS 232 internet cable 8 as shown in FIG. 1. A computer with a web browser 9 which is in communication with the internet 7 may then be used to control the web relay 3, which thereafter controls “on” or “off” the motor 2.

One example of the prior art web relay 3 as discussed above are those manufactured by Xytronix Research and Design, Inc., 683 West 1725 North, Logan, Utah, 84321 USA which are used in implementing a system such as shown in FIG. 1.

FIG. 2 shows a prior art system for remotely controlling the electrical power supply 4 to an electric motor 2, using a pair of web relays 3 via an IP network/internet 7, to which each of such web relays 3 are connected via RS 232 internet cable 8. In such prior art method/system of FIG. 2, the computer and web browser 9 of FIG. 1 is not needed, and instead a simple “on/off” switch 12 may be provided at the remote location (remote from the location of the electric motor 2) to control the “on” and “off” of the motor 2 remotely by controlling the electrical power 4 thereto.

FIG. 3 shows a prior art system as disclosed in a publication by M2M Datacorp. “Universal Device Access”, by Donald I. Wallace, Mar. 24, 2003, for supervisory control and data acquisition (SCADA), which allows for internet control and monitoring of remote equipment 2 to allow operating parameters of such remote equipment 2 to be displayed and/or used for alarming, trending or reporting purposes. In such method/system, operating parameters with respect to the monitoring of remote equipment 2 are digitally communicated at a remote location 11 to an internet gateway 18, which via a communications network 13 (which may be via co-axial cable, digital satellite, WAN, or via telephone cable via ASDL signal transmission). Communications network 13 communicates such data, typically in XML (“Extensible Markup Language”, namely a meta-language written in SGML that allows one to design a markup language, to allow for the easy interchange of documents on the World Wide Web) to an internet service provider 14, and thereafter to a SCADA service provider 15 who operates a web page over the internet 7. A client 20 may, using a standard browser such as Microsoft™ internet Explorer™ or Mozilla Firefox™, log on to the service provider 15 web page, and acquire or view the digital data regarding the operation of the remote equipment 2. The web site of the SCADA service provider may provide also a sophisticated program for making use of and intelligently displaying the XML data which is displayed, or which may be downloaded by client 20.

U.S. Pat. No. 7,346,403 to Yeh et al relates to an interface for connecting one of a plurality of devices at a remote location to a communications medium for remote monitoring and control of industrial machines, including but not limited to air compressors, boilers, chillers, distributed generators and heating, ventilation and air conditioning equipment, via the internet. The programmable apparatus has a memory for storing data in pre-determined locations, and for receiving machine data and transforming the data to a predetermined format, and a communications port.

WO 99/3905 to Kavy teaches a networked security system for network-based monitoring and control of a remote system via said network. The system is adapted to receive data packets from a remote site control unit via the network, and for processing the data packets received from such remote site control units for access by a networked user. The wide-area network includes the internet.

Importantly, the prior art systems, including the above, contemplate the equipment which is desired to be monitored being proximate to, and readily accessible to, the internet. In numerous remote locations, however, internet access which may be by telephone cable (ASDL) connection, co-axial cable, or digital satellite (which is typically only “line of sight” to a transmitter tower) may not be available, and accordingly such means of monitoring (and/or control) in the prior art is not possible.

In addition, in such prior art systems as shown in FIG. 3 herein, data from the remotely-monitored equipment is typically conveyed in XML format, to facilitate ready manipulation by computers accessing such data using customized programs adapted to handle XML data. Such data format, however, typically requires large bandwidth which in turn requires local access to the internet (ie an internet gateway) at the remote location in order to handle such large bandwidth requirements.

Regarding pumpjacks and their manner of operation and need for constant monitoring and control, pumpjacks are used for pumping oil from underground hydrocarbon formations. Conditions under which such pumpjacks operate can vary continuously, depending on the pressure of the formation, the ambient temperature and temperature of the pumped fluid.

Problematically, while some hydrocarbon formations and associated pumpjacks may fortuitously be situated proximate to an electric utility grid and relatively close to industrial metropolitan conveniences such as internet gateway access, frequently pumpjacks are located in remote locations and need be powered by self-contained internal combustion motors. In addition, and particularly when operated by self-contained internal combustion motors, pumpjacks have a number of operational parameters which need be constantly monitored for optimum production and efficiency and to avoid certain undesirable conditions such as a “pump off” condition where a pumpjack is attempted to be operated at a speed which is too high for the conditions in which the oil can flow and be pumped to be able to withdraw the oil from the ground. The remote location of the pumpjacks is a difficult obstacit in the effort to continuously monitor such pumpjacks for efficient and continuous operation.

Thus there is a clear need, and it is very advantageous to pumpjack owners and operators, to be able to frequently and continuously monitor the operation of a pumpjack, and to further be able to remotely control its operation, even when such remotely-located pumpjack may not be in a region where there is local access to an internet gateway.

Specifically, there is a real need for owners and operators of pumpjacks to remotely be able to monitor the operation of pumpjacks and to further be able to control the operating parameters of pumpjacks, such as but not limited to pumpjack upstroke length, pumpjack downstroke length, the pump speed, the pump upstroke force, and the pump downstroke force of a pumpjack, to ensure best and continued operation of such remotely-located pumpjacks.

### SUMMARY OF THE INVENTION

Accordingly, as a means of overcoming the shortcomings of the prior art with respect to monitoring and control of remotely-situated pumpjacks, the present invention allows for simple and effective remote monitoring and control of pumpjacks in remote locations in which access to the internet (world-wide web) is not (or is not readily) available at such remote locations, but where cellular telephone wireless coverage is available.

Accordingly, in one broad aspect of the present invention such invention comprises a system to permit a user to remotely monitor via said user's computer timely operating characteristics of a pumpjack situated at a distant site but within wireless cell phone station reception, comprising;

one or more monitoring sensors situated on or proximate said pumpjack, adapted to monitor and create analog output of operational conditions of said pumpjack;

digitizing means to digitize said analog output data to digital data;

a network server, located remotely from said pumpjack and in communication with the Internet;

modem means for transmitting said digital data via a wireless cellular network to said network server and uploading said digital data to said network server; and

a graphical user interface (GUI) installed on said user's computer, capable of accessing said network server when providing a password to said network server, to thereby allow access to said digital data of said pumpjack's operating characteristics. a system for remotely monitoring a pumpjack situated at a distant site but within wireless cell phone station reception, such system comprising;

one or more monitoring sensors situated on said pumpjack, adapted to monitor and create analog output of operational conditions of said pumpjack;

digitizing means to digitize said analog output data to digitize said analog output data to digital data;

a network server, located remotely from said pumpjack and in communication with the Internet;

modem means for transmitting said digital data via a wireless cellular network to said network server and uploading said digital data to said network server; and

a graphical user interface (GUI) installed on said user's computer, capable of accessing said network server when providing a password to said network server to thereby allow access to said digital data of said pumpjack's operating characteristics.

In a further refinement of the above system, such system is further adapted for both remotely controlling and monitoring said pumpjack, wherein:

said graphical user interface (GUI) is further adapted to permit a user to select different operational parameters for said pumpjack,

said system further comprising:

means for converting a desired selected operating characteristic of said pumpjack into a telnet command;

second modem means for receiving telnet commands and transmitting said telnet commands wirelessly to a cell phone network; and

control means operatively connected to said pumpjack adapted to receive said telnet command from said wireless cellular network for controlling and varying at least one operating parameter of said pumpjack in accordance with said received telnet command.

In a further aspect of the present invention, such invention comprises a method for remotely monitoring via a users computer a pumpjack situated at a distant site but within wireless cell phone station reception and transmission, comprising;

sensing, via one or more monitoring sensors situated on said pumpjack, an operating condition of said pumpjack;

creating an analog output of said operational condition of said pumpjack;

digitizing said analog output data via digitizing means to digitize said analog output data to digital data;

transmitting said digital data from said digitizing means, via first modem means connected to said digitizing means and via a wireless cellular network, to a network server and uploading said digital data to said network server; and

accessing from a user's computer operating a graphical user interface (GUI) said network server in order to view such digital data.

In a further refinement of the above method of the present invention, the method allows for both controlling as well as monitoring the operating conditions of said pumpjack, further comprising the steps of:

utilizing said graphical user interface on said user's computer to select a desired operating condition for said pumpjack;

communicating said desired operating condition to said network server;

transmitting, from said network server, over a wireless cellular network, and via a second modem, said desired operating condition to said first modem and thereafter to control means situated proximate said pumpjack; and

controlling, via said control means, said pumpjack to allow said pumpjack to operate in accordance with said selected operating condition.

### BRIEF DESCRIPTION OF THE DRAWINGS

Further advantages and permutations and combinations of the above elements will now appear from the above and from the following detailed description of various non-limiting embodiments of the invention, taken together with the accompanying drawings, in which:

FIG. 1 is schematic view of a prior art system for controlling equipment via the internet;

FIG. 2 is a schematic view of a different prior art system for controlling equipment over the internet, but which lacks a computer;

FIG. 3 is a third prior art system for controlling remote equipment via the internet;

FIG. 4 is a schematic of a monitoring and control system of the present invention for a remotely-located pumpjack;

FIG. 5 is a flow chart of a method of the present invention for monitoring operational parameters of a remotely-located pumpjack;

FIG. 6 is a flow chart of a method of the present invention for controlling operational parameters of a remotely-located pumpjack;

FIG. 7 is a flow chart of a method whereby a user accesses a network in order to acquire access to downloaded pumpjack operating parameters;

FIG. 8 is a detailed flow diagram of a particular embodiment of the method of the present invention for controlling and monitoring certain particular parameters in the operation of a pumpjack, which utilize both monitoring and control of pumpjack operating conditions;

FIG. 9 is a schematic view of the controller of the present invention for operating the pumpjack; wherein the controller is in direct communication via the internet with a computer having a graphical user interface; AND

FIG. 10 is a detailed description of the wiring for connection to the controller (control means).

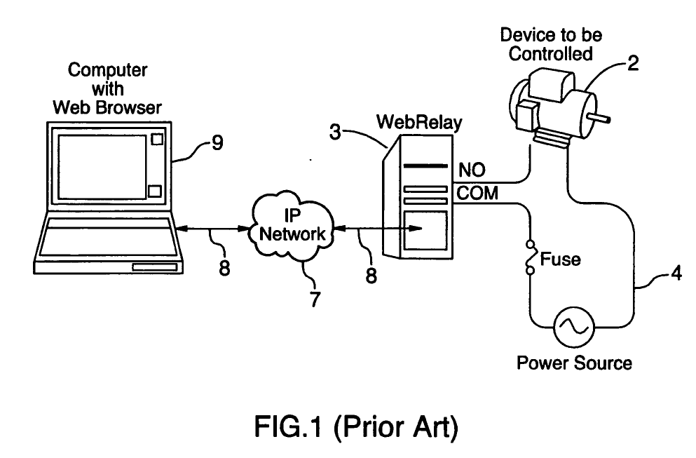

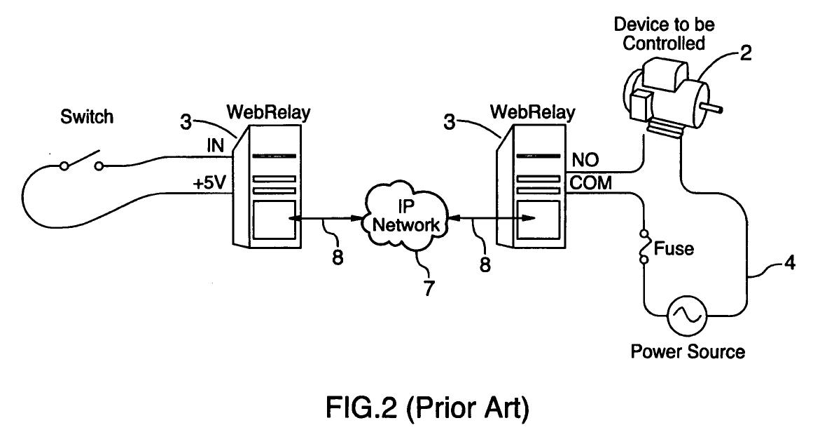

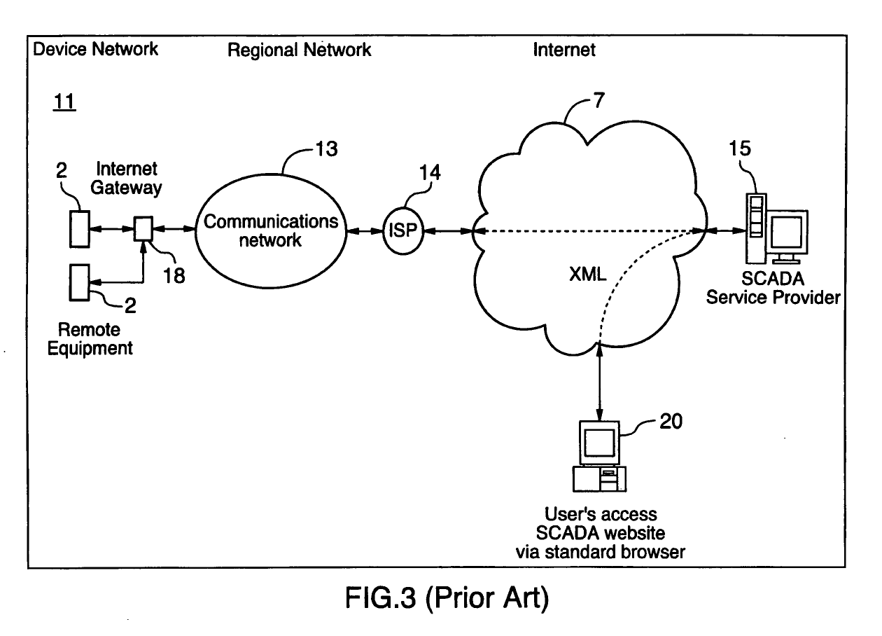

### DETAILED DESCRIPTION OF PREFERRED EMBODIMENTS

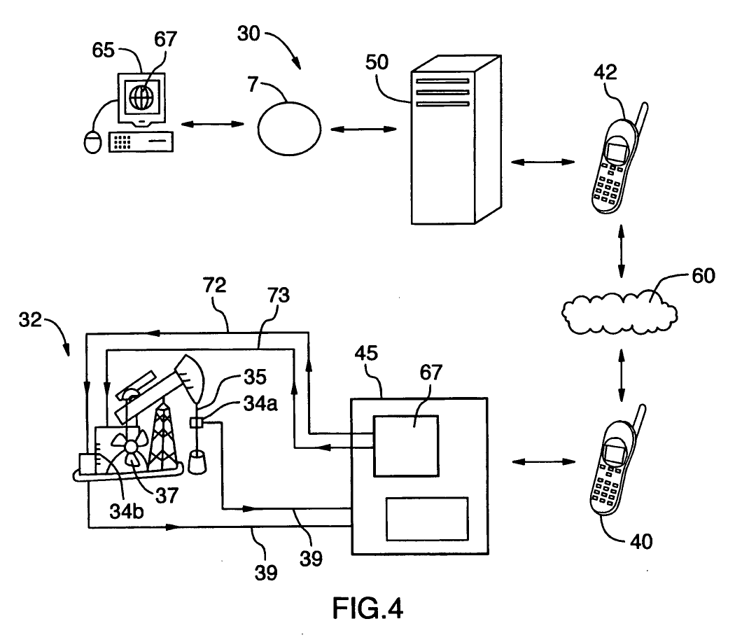

FIG. 4 schematically illustrates a preferred system 30 and method of the present invention.

Specifically, as seen from FIG. 4, the system 30 comprises a pumpjack 32, remotely situated, but in a region of cellular telephone transmission, having a plurality of monitoring sensors 34a, 34b thereon. In the embodiment shown in FIG. 4, sensor 34a is a load cell sensor, effectively a strain gauge, located on the polish rod 35 of pumpjack 32, which provides an electrical output [which output is typically analog and is digitized to a digital output by digitizing means (not shown) internal to the load cell sensor 34a or external to load cell sensor 34a], and which provides digital values for the force applied to polish rod 35 of the pumpjack 32.

Sensor 34b is a speed sensor, which provides, via digitizing means (not shown) a digital output of the speed of the motor 37 of pumpjack 32.

Other similar sensors (not shown), together with sensors 34a, 34b, may be provided on pumpjack 32 to provide operational data of the pumpjack operating parameters, including but not limited to such typical and frequently monitored pumpjack operational parameters as polish rod upstroke travel distance, polish rod downstroke travel distance, pumpjack motor speed, polish rod speed, polish rod upstroke force, and polish rod downstroke force, which may then be used alone as an operational control and/or further used in a pump production equations for determining other operating conditions such as pumpjack volumetric pump output, pumpjack power consumption, stresses on pumpjack components (eg stress equations), and the like.

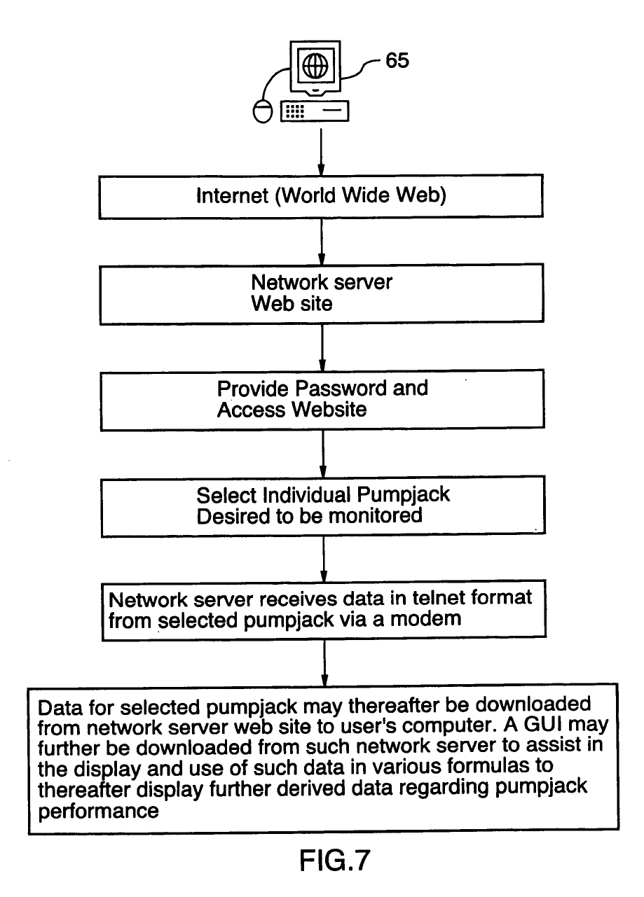

Digital operating data from sensors such as 34a, 34b, flow meter 34c (see FIG. 7), and/or the current “state” of various on/off switches 34(f-g)—see also FIG. 7) is communicated by lines 39 to controller 45 (which may be a computer), and thereafter transmitted wirelessly via first wireless modem (modulating/demodulating) device 40 over a cellular telephone network 60. In an alternative embodiment (not shown in FIG. 4), each sensor 34a, 34b may transmit directly via lines 39 directly to a respective dedicated wireless modem 40. In both scenarios, first modem 40 thereafter transmits the collected digital wirelessly via a wireless cellular telephone network, to a second modem 42.

Digitized data received by second modem 42 is acquired on a network server 50, such network server 50 operatively connected to a WAN or internet.

A user desiring to access the digitized data of the pumpjack operating conditions then uses a user computer 65 to log onto the internet 7, and in particular to log onto and acquire access, typically through provision of a password, to the digitized data for the desired pumpjack 32.

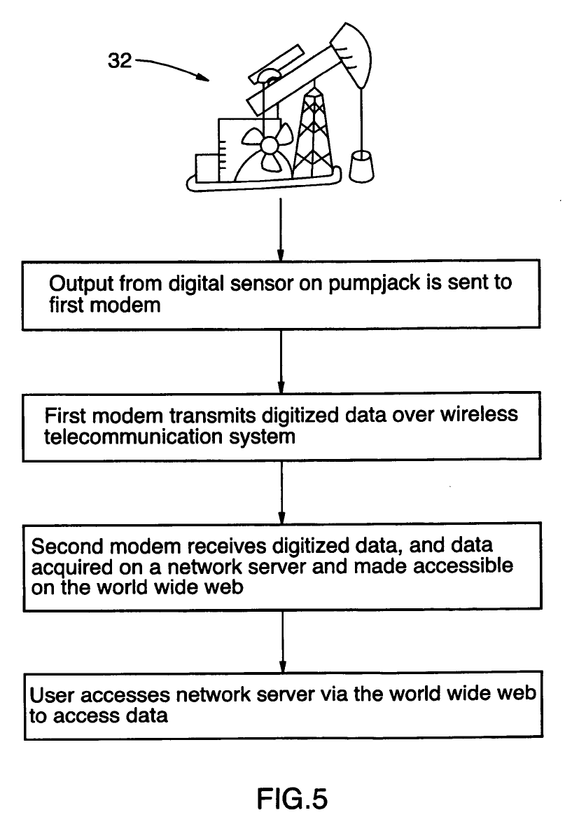

FIG. 5 shows a flowchart of the method of the present invention, for remotely monitoring the operating conditions of the pumpjack 32.

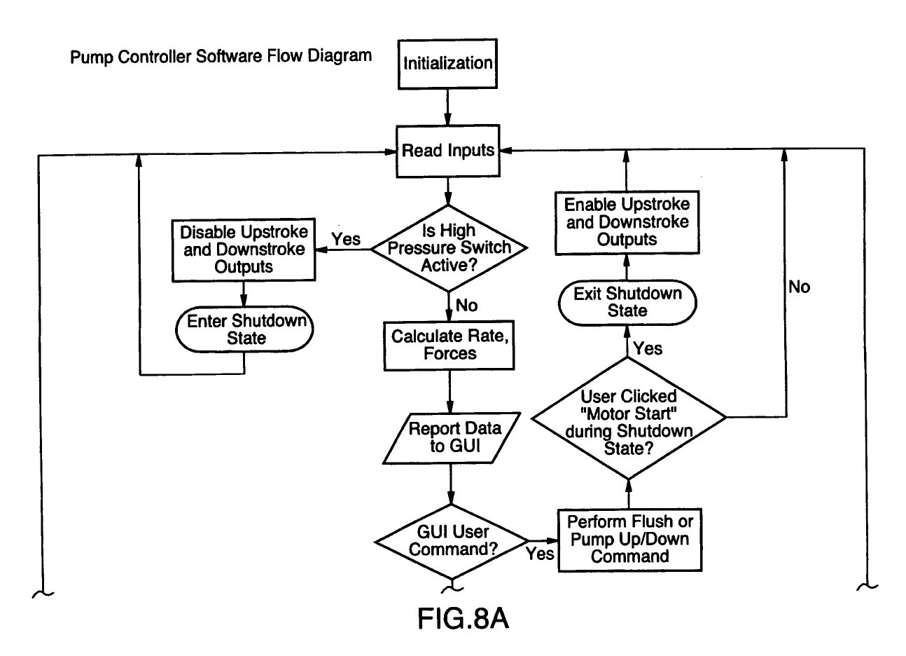

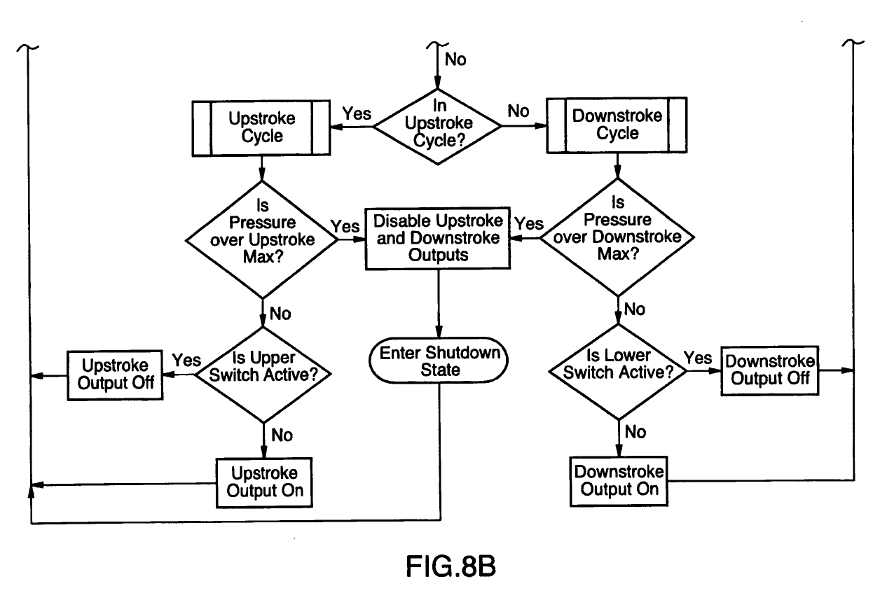

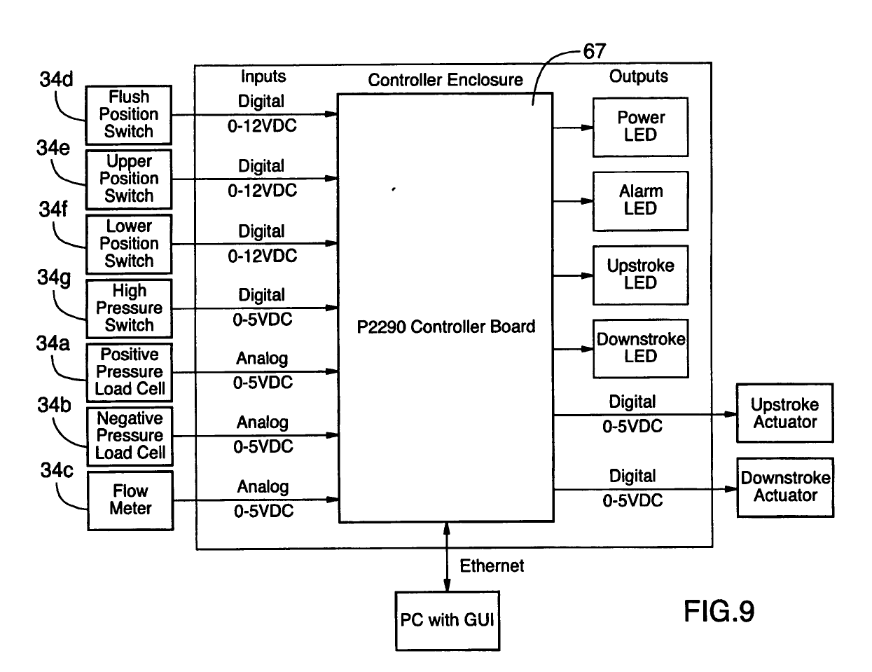

As noted in the flowchart shown in FIG. 5, digitized data of the operating parameters of the pumpjack, such as the position of switches (eg. Flush Position Switch, Upper Position Switch, Lower Position switch, High Pressure Switch, and measurement of pump flow) are obtained from sensors 34d-34g and 34c respectively (see FIG. 9). Such data is digitized and provided to first modem 40 which transmits the digitized data over a wireless telecommunication system 60. Second modem 42 receives the digitized data, and such data is then acquired by network server 50, and made accessible on the internet web 7 or a WAN (wide area network). A user, or alternatively a computer software program for monitoring pumpjack 32, such as that set out in FIG. 8, accesses the data on network server 50 via the internet 7 or WAN.

FIG. 7 is a further elaboration of the method by which a user employing a user computer 65 may access the web to to display and use operational data which has been supplied to network server 50.

When a user desires to change or control the operational parameters of the remotely-located pumpjack 32, the same components of the system 30 described above can be used.

Specifically, as may again be seen from FIG. 4, when a user desires to change or control the operational parameters of the remotely-located pumpjack 32, user computer 65 is used by the user to access the internet 7 (or a WAN) and log onto network server 50. A graphical user interface 67, (accessible by the user on a web site hosted by the network server 50, or instead operated by user computer 65) is used by the user to provide and select the desired operational condition for the desired pumpjack 32. Network server 50 thereafter, via second modem 42 and via telnet commands, transmits the desired pumpjack operating conditions over cellular telephone network 60 to the first modem 40. Thereafter, control means 45, typically a printed circuit board 67 (in one embodiment a P2290 Controller Board as shown in FIG. 7) receives telnet commands, and regulates (actuates/deactuates) various pumpjack controls, for example switches 34d, 34e, 34f, and/or 34g (see FIG. 9) via wires 72,73 (see FIG. 4).

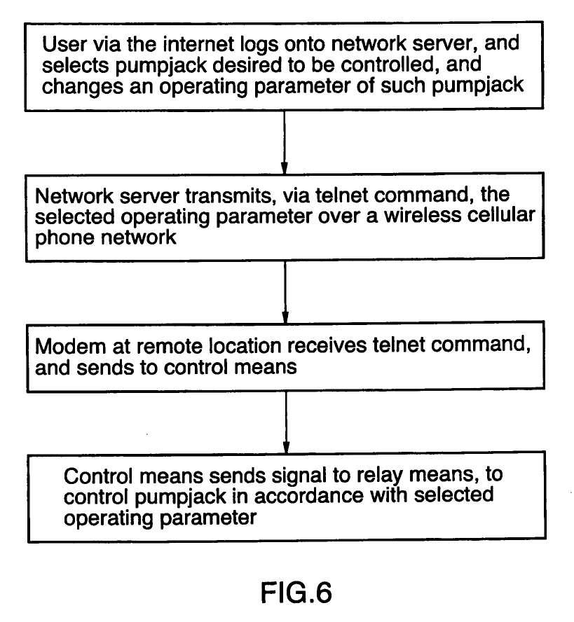

Again, the method by which a user (or a computer software programs automatically controls a pumpjack) is broadly set out in the flowchart depicted in FIG. 6.

Specifically, as may be seen from FIG. 6, a user via the internet 7 or a WAN logs onto network server 50, and selects the pumpjack 32 desired to be controlled, and changes one or more operating parameters of pumpjack 32 via a graphical user interface. Network server 50 thereafter transmits, via telnet commands or such programming language as PHP, the selected operating parameters over a wireless cellular phone network 60 via wireless modem 42. Wireless modem 40, situated at the remote location as pumpjack 32, provides the commands to controller 45, and specifically a printed circuit board 67 therewithin, a preferred embodiment of such circuit board being shown in FIG. 9. The controller then controls relays to thereby operate various switches, such as 34d-34g, to thereby regulate pumpjack 32 operating conditions.

FIG. 8 shows a particular pump controller software flow diagram, making simultaneous use of both the monitoring and control aspects of this invention for monitoring and controlling remotely a pumpjack 32. Such pump controller software may be run on the network server 50 when access is given over the internet 7 to user computer 65, or may be run on user computer 65 likewise when access is given over the internet 7 or a WAN to network server 50.

FIG. 9, as indicated above, shows the various pump operational parameters which can be controlled, and which can be further determined as to their “state” by sensors 34d-34g. Various LED indicators (indicative of, for example, power being supplied) are outputted, and may provide output which may be communicated to modem 40 and thereafter to modem 42 and to network server 50 in the manner described above, to allow a user to be aware of the “state” of these operational parameters for pumpjack 32.

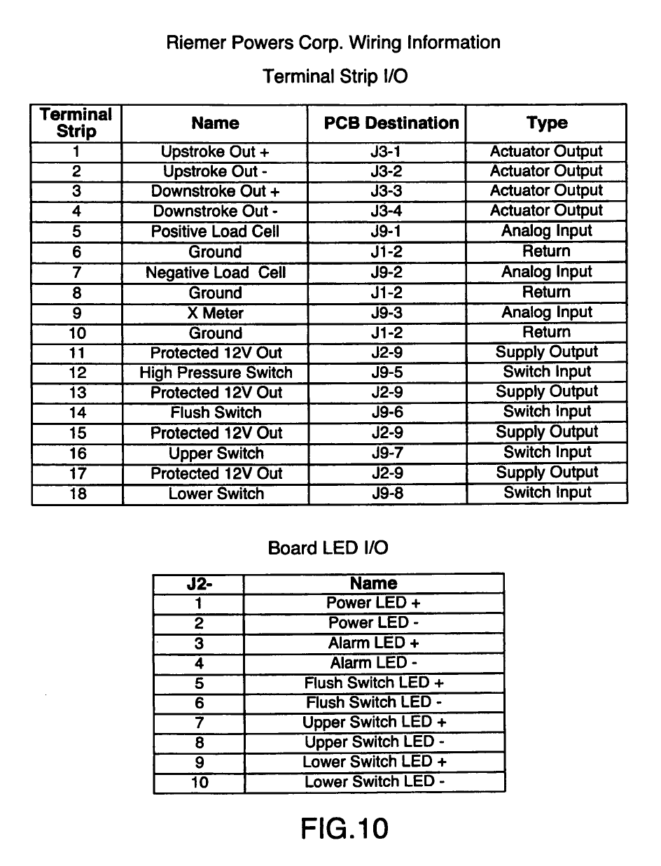

FIG. 10 is a terminal strip input/output description for the P2290 Controller Board 67 shown in FIG. 9, showing the various terminals 1-18 on the P2290 Controller Board which are used to control the various pumpjack operational parameters, such as the flush switch (which is sensed by sensor 34d—see FIG. 9).

Although the disclosure describes and illustrates preferred embodiments of the invention, it is to be understood that the invention is not limited to these particular embodiments. Many variations and modifications will now occur to those skilled in the art. For a complete definition of the invention and its intended scope, reference is to be made to the summary of the invention and the appended claims read together with and considered with the disclosure and drawings herein.

We claim:

1. A system to permit a user to remotely monitor via said user's computer timely operating characteristics of a pumpjack situated at a distant site but within wireless cell phone station reception, comprising;
one or more monitoring sensors situated on or proximate said pumpjack, adapted to monitor and create an analog output of operational conditions of said pumpjack;
digitizing means to digitize said analog output data to digital data;
a network server, located remotely from said pumpjack and in communication with the world wide web;
first modem means for transmitting said digital data via a wireless cellular network to said network server and uploading said digital data to said network server;
a graphical user interface (GUI) installed on said user's computer, capable of accessing said network server when providing a password to said network server, to thereby allow access to said digital data of said pumpjack's operating characteristics.

2. The system as claimed in claim 1, wherein said digitized data is transmitted via said wireless cellular network via telnet protocol.

3. The system as claimed in claim 1, wherein said GUI is installed on said network server, and is downloaded from said network server to said user's computer.

4. The system as claimed in claim 1, wherein said GUI possesses means to permit downloading of said digital data to said user's computer and means for displaying said digital data on said user's computer.

5. The system as claimed in claim 1, wherein said system monitors at least one pump operating parameter selected from the group of pump operating parameters comprising pump upstroke length, pump downstroke length, pump speed, polish rod speed, pump upstroke force, and pump downstroke force.

6. The system as claimed in claim 1, further adapted for both remotely controlling said pumpjack, wherein:
said graphical user interface (GUI) is further adapted to permit a user to select different operational parameters for said pumpjack,
said system further comprising:
means for converting a desired selected operating characteristic of said pumpjack into a telnet command;
second modem means for receiving telnet commands and transmitting said telnet commands wirelessly to a cell phone network; and
control means operatively connected to said pumpjack adapted to receive said telnet command from said wireless cellular network for controlling and varying at least one operating parameter of said pumpjack in accordance with said received telnet command.

7. The system as claimed in claim 6, wherein said network server is adapted, in response to said selected operational parameter received from said graphical user interface, to issue telnet commands to said second modem.

8. The system as claimed in claim 6, wherein said system controls at least one pump operating parameter selected from the group of pump operating parameters comprising pump upstroke length, pump downstroke length, pump speed, polish rod speed, pump upstroke force, and pump downstroke force.

9. A method for remotely monitoring via a user's computer a pumpjack situated at a distant site but within wireless cell phone station reception and transmission, comprising;
sensing, via one or more monitoring sensors situated on said pumpjack, an operating condition of said pumpjack;
creating an analog output of said operational condition of said pumpjack;
digitizing said analog output data via digitizing means to digitize said analog output data to digital data;
transmitting said digital data from said digitizing means, via first modem means connected to said digitizing means and via a wireless cellular network, to a network server and uploading said digital data to said network server; and
accessing from a user's computer operating a graphical user interface (GUI) said network server.

10. The method as claimed in claim 9, said step of transmitting said digital data via a wireless cellular network to a network server being carried out by telnet protocol transmission.

11. The method as claimed in claim 9, further comprising the step of, prior to said step of said user's computer operating a GUI, downloading said GUI from said network server to said user's computer.

12. The method as claimed in claim 9, further comprising the step, after said step of accessing said network server via said GUI, of downloading said digital data to said user's computer and displaying said digital data on said user's computer.

13. The method as claimed in claim 9, wherein said sensor senses, and said method thereafter permits monitoring of, at least one operating parameter selected from the group of pump operating parameters comprising pump upstroke length, pump downstroke length, pump speed, polish rod speed, pump upstroke force, and pump downstroke force.

14. The method as claimed in claim 9 above for both monitoring and controlling operating conditions of said pumpjack, further comprising the steps of:
utilizing said graphical user interface (GUI) on said user's computer to select a desired operating condition for said pumpjack;
communicating said desired operating condition to said network server;
transmitting, from said network server, over a wireless cellular network, and via a second modem, said desired operating condition to control means situated proximate said pumpjack; and
controlling, via said control means, said pumpjack to allow said pumpjack to operate in accordance with said selected operating condition.

15. The method as claimed in claim 14, wherein said method is adapted to control at least one pump operating parameter selected from the group of pump operating parameters comprising pump upstroke length, pump downstroke length, pump speed, polish rod speed, pump upstroke force, and pump downstroke force.
